(19) United States
(12) Patent Application Publication
(10) Pub. No.: US 2004/0128197 A1
(43) Pub. Date: Jul. 1, 2004

(54) System and method of generating, distributing, and/or redeeming promotional offers using electronic devices

(75) Inventors: Ajay R. Bam, Belmont, MA (US); Robert J. Wesley, Wellesley, MA (US); Walter Stock, Newton, MA (US); Troy Chen, Jersey City, NJ (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Vayusa, Inc., Newton, MA

(21) Appl. No.: 10/691,459

(22) Filed: Oct. 22, 2003

Related U.S. Application Data
(60) Provisional application No. 60/420,642, filed on Oct. 23, 2002.

(51) Int. Cl. G06F 17/60

(52) U.S. Cl. 705/14

(57) ABSTRACT

A system for the distribution, redemption, and use of electronic promotions is disclosed. The electronic promotions can be generated using specific consumer profiles and sent directly to a consumer's electronic device. At the time of purchase, the electronic promotions can be automatically applied to the purchase under control of the consumer's electronic device. In one embodiment, the electronic device is a mobile device.

### PRIORITY

The present application claims priority to Provisional Patent Application Serial No. 60/420,642, filed Oct. 23, 2002, entitled “A SYSTEM DESCRIBING THE METHOD OF GENERATING, DISTRIBUTING AND REDEEMING COUPONS ELECTRONICALLY IN SMS (SHORT MESSAGE SERVICE), MMS (MULTI-MEDIA MESSAGE SERVICE) OR VOICE FORMATS FOR A MOBILE DEVICE.”

### CROSS-REFERENCE TO RELATED APPLICATIONS

The present application is also related to co-pending, and commonly assigned U.S. Patent Application Ser. No. 10/645,579, filed Aug. 22, 2003, entitled “SYSTEM AND METHOD OF INTEGRATING LOYALTY/REWARD PROGRAMS WITH PAYMENT IDENTIFICATION SYSTEMS,” which claims priority to Provisional Patent Application Serial No. 60/420,643, filed Oct. 23, 2002, entitled “A PAYMENT SYSTEM INTEGRATING LOYALTY/REWARD PROGRAMS,” the disclosures of which are hereby incorporated herein by reference.

### TECHNICAL FIELD

The present invention relates to the telecommunications industry, the payment industry, loyalty/reward programs management and the point of sale (POS) industry. Particularly, it relates to generation, distribution, and/or redemption of promotions such as coupons and other promotional offers, using electronic devices, and even more particularly to such systems where the electronic devices are mobile.

### BACKGROUND OF THE INVENTION

Given a choice of similar providers, consumers tend to patronize the merchant that provides the consumer more value for the same price, or the same value at a lower price. To influence a consumer's choice of provider, merchants often provide promotions, for example coupons, regarding goods such as groceries, consumer electronics, clothing, and other items that may be purchased in person, over the phone, or electronically. In this context, a coupon is a promotion used as a tool by merchants to encourage sales, usually by lowering the price in some manner. For example, a coupon could be used for a discount on the product, to give the consumer a larger quantity (for example, 2 for 1) of a product or service, or a discount on a related product or future purchase. A coupon could also be used to credit purchases made by one person against a certain account. Thus, a school could get credits (money or otherwise) for purchases made by any one of a number of people having affinity to the school (affinity groups). The possibilities for coupon usage are essentially unlimited.

Coupons and other promotions are often used by merchants as marketing tools designed and developed to encourage a change in purchase behavior, retain valued customers and to induce repeat purchases. Traditional promotions have been paper based, and usually have a cash or material purchase value, such as prepaid gift cards. Rather than be directed toward a single product, they may be an incentive to buy accessories with a particular item, or promotions may even be promotional offers to sell. Overall, promotions serve to attract consumers to a store, to a particular product or brand in a store, as well as bring attention to new products and keep track of an individual consumer's buying habits.

### BRIEF SUMMARY OF THE INVENTION

Embodiments of the present invention are directed to an electronic promotion system that includes software to produce electronic promotions in various formats (graphic or non-graphic). In one embodiment, electronic coupons are sent to targeted consumers on consumer's mobile electronic devices or web portal accounts. The coupons may be voice based, text based, or graphics based, and can be tailored to a specific consumer's profile. The coupons received can then be redeemed by the consumer in various ways depending on the coupon, provider, merchant, and/or point of sale location. The electronic coupons may also be electronically saved by both the consumer and the merchant to designated coupon saving accounts for later use. The coupon account can be located on a consumer's mobile electronic device, or it may be located on a remote server.

When a consumer encounters a point of sale (POS) location, the consumer's electronic coupons can be automatically redeemed by reading them from the saved location. At the time of redemption, the coupon can be matched with the purchased items, the expiration date, and other relevant information.

In one embodiment, the coupons can be assigned to accounts linked to specific consumers based on an identification of the consumer's mobile device. The coupons may also be linked to the inventory control or accounting systems of the providing merchants for balancing accounts. Coupons saved by the merchant can be integrated with marketing tools and data analysis tools to monitor redemption rates or to create new coupons based on redemption profiles. Merchants may further monitor the individual redemption of specific consumers.

The foregoing has outlined rather broadly the features and technical advantages of the present invention in order that the detailed description of the invention that follows may be better understood. Additional features, and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates one embodiment of an electronic promotion system;

FIG. 2 illustrates an embodiment of a text based electronic promotion system;

FIG. 3 illustrates an embodiment of an electronic voice based electronic promotion system; and

FIG. 4 illustrates an embodiment of an electronic promotion distribution and redemption system.

### DETAILED DESCRIPTION OF THE INVENTION

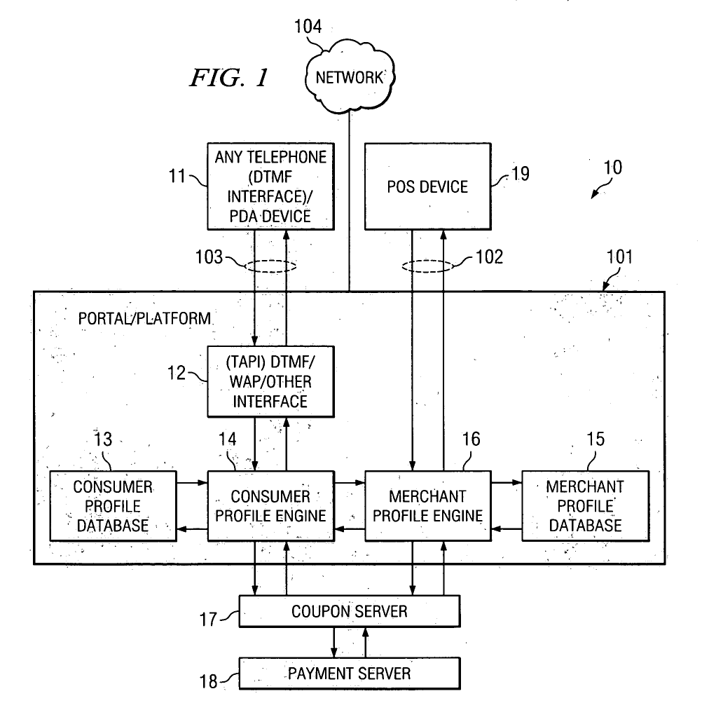

FIG. 1 illustrates one embodiment of system 10 for providing electronic promotions. The embodiments of the present invention are not limited to anyone type of promotion, and thus may use coupons, discounts, alerts, offers to sell goods or services, or other similar promotion. The embodiment of FIG. 1 has been illustrated and described as distributing coupons, but may be readily adapted for any promotion. Electronic device 11 can be any electronic device commonly used by a consumer, including but not limited to, land based or cellular telephones, computers, personal digital assistants (PDA's), pocket organizers, or other similar devices capable of receiving and/or sending data through an appropriate commercial or private transmission network 103, whether wireless, wireline, or a combination thereof.

Using the example of a cellular telephone, the depicted embodiment can use a dual tone multi-frequency (DTMF) system that allows consumers to access the couponing system via the touchtone keys on their mobile phone. The embodiments of the present invention are not limited to DTMF type systems, but rather may be easily adapted to a wireless application protocol (WAP) client, Bluetooth technology, RFID, or any other technology for enabling the transaction. When a consumer uses device 11 to conduct a payment transaction over a mobile phone (or other mobile electronic device), system 10 uses telephony application program interface (TAPI) 12, which detects the DTMF touchtones. Rather than touchtones, device 11 may alternatively receive and/or generate text messages formatted in a pre-defined language. For example, text message “coupon now clothes from XYZ” could mean that the consumer using the electronic device is requesting a coupon for clothes from XYZ for use at a merchant, today.

System 10 may also incorporate one or more types of security levels to identify a consumer, including but not limited to, equipment ID, caller ID and/or a unique consumer pin number. Wireless standards in the United States associate one telephone number with one mobile phone, thereby allowing system 100 to identify the end consumer via the unique telephone number. Other secure identification methods, such as biometrics, voice recognition, or other client based secure methods may also be used.

In FIG. 1, platform 101 includes device interface 12, consumer profile database 13, merchant profile database 15, consumer engine 14, and merchant engine 16. Platform 101, in the embodiment shown, may use XML or similar technology, along with one of the many API's (Application Program Interfaces) currently available in the market, that will allow platform 101 to communicate to any device. Platform 101 may also provide a web interface, for example, network 104, where end users and merchants can access and manage their respective account.

Device interface 12 is the gateway for receiving voice or text messages from device 11 and directs the messages to consumer engine 14, which can further access the consumer's profile from consumer profile database 13. Device interface 12 also converts incoming voice messages into a text based message to be forwarded to consumer profile engine 16. The text based messages may be in any appropriate language format such as XML, C++, Java, or the like.

Consumer profile engine 14 interprets all incoming messages and directs them to merchant profile database 15, coupon server 17, or payment server 18. Consumer profile database 13 stores all consumer related information including, but not limited to, transactions, loyalty program information, coupons, as well as pre and post redemption information for each consumer.

A voice or a text message may be received from any device, in any format, such as the text message “coupon now clothes from XYZ” sent from device 11. If the request is for a coupon, then a request for a coupon is tagged with consumer information from consumer profile database 13 and sent by consumer profile engine 14 to coupon server 17. If the message is for the redemption of a coupon, then the coupon is tagged with information about the requester and saved into consumer profile database 13 for any current or future use by the consumer, and, if desired, by the merchant.

Merchant profile engine 16 provides access to merchant profile database 15 containing information about each merchant and its respective transactions. Merchant profile database 15 contains information about each merchant's loyalty programs, coupon programs, and rewards. Merchant profile database 15 stores the information about a merchant, including its profiles, transactions, marketing information and loyalty program rules. When a new promotion is sent to a consumer, data pertaining thereto is registered with the database. Merchant profile database 15 is then accessed through merchant profile engine 14 by coupon server 17 as needed to receive, send, or process coupons. Merchant profile engine 16 can query merchant profile database 15 to determine the loyalty rules, and other established parameters for each merchant.

Coupon server 17, as an example promotion distributing processor, holds the logic to process coupons, receive coupons, or send coupons. Coupon server 17, upon receipt of a coupon request either to send, redeem, or simply search for information pertaining to a coupon, processes the request based on logic defined in coupon server 17, and acts as a gateway for coupon logic. The request for a new coupon may contain information regarding the requester, the merchant, date, or other specifics. This request is processed under the direction of coupon server 17, and in cooperation with engines 14 and 16 to generate a coupon based on the request. To generate the coupon, coupon server 17 may query merchant profile engine 16 to retrieve specific merchant based coupon information from merchant profile database 15. Coupon server 17 may also query consumer profile engine 14 to retrieve consumer based coupon information from consumer profile database 13. Other databases may also be queried as necessary. The generated coupon is then sent back to consumer profile engine 14 to be forwarded to interface 12 for delivery to device 11. Depending on the type of request, the coupon may be sent in a voice format, SMS format, or MMS format, or a combination thereof.

If the request is to redeem a coupon, then the coupon characteristics are matched with payment information to apply the appropriate logic for redemption. The redemption logic is based on the merchant's profile, coupon information, and consumer profile obtained, as discussed above. A redemption may be a free purchase, a reduction in price, an auxiliary purchase, or any other promotion as defined for the redeemed coupon. If the request was a redemption, then the post redemption message is sent back to device 11 and to merchant profile database 15, and, if desired, to consumer database 13.

Transactions processed by system 10 also be further processed by one or more of the checking (ACH)/ATM/Debit/Credit card or other transaction networks and this is accomplished through server 18. Depending on the type of transaction, the payment data is routed to the appropriate processing entities, and may require system 10 to request payment based information from the consumer.

After a promotion has been redeemed and all the loyalty program rules have been applied, the total dollar amount is sent to payment server 18 for processing. An ACH is a secure electronic fund transfer system that connects financial institutions. The ACH network acts as the central clearing facility for Electronic Fund Transfer (EFT) transactions that occur nationwide. ATM debit and credit card transactions are sent to the appropriate banks for approval and clearing. These will be done through different ATM debit or credit networks, such as Cirrus, NYCE, Maestro, Visanet, etc.

When device 11 is mobile, the user can process promotions at a POS terminal by calling up the desired promotion via the mobile device. If desired, this can be accomplished concurrently with payment control, as discussed in the above-identified patent application. System 10 may prompt the user to enter specific information regarding a POS (such as POS location ID) and/or specific information regarding the purchase. As further described in the above identified application, system 10 can offer consolidation, convenience, and management of multiple consumer reward programs in one place, such as a website, and further enables the use of promotional information at a physical or virtual location using any electronic device. The customer's device may be wired or wireless and may operate through dial up or via GPRS, WIFI and/or other networks. Using a system like system 10, a consumer could register a new or existing payment and loyalty cards/accounts, such as checking or savings accounts, debit, credit or loyalty cards with a web portal at any POS or by calling a designated telephone number. Once the user connects with the portal, the user selects which card (or cards) he/she desires, which loyalty programs he/she is eligible for, and/or which stored value cards the user desires to link to his/her mobile payment account. Different cards and programs may be used in different stores, if desired.

Assuming a merchant (enterprise) has enabled system 10 to handle payments (or identification) any of that merchant's POS locations 19 can be used by a prospective recipient of goods/services. In one embodiment, the merchant can go on line and sign up and also each recipient, or prospective recipient, can go on-line (or otherwise sign up). In doing so, the recipient user goes to the web portal, signs up for payment methods and loyalty cards, and registers his/her existing payments and loyalty cards. The user can sign up for new cards at this or anytime, if so desired. All of the customer's and merchant's specific data will be stored in a secure form on the respective database 13, 15. When a user uses the system, if that user is enrolled in a loyalty program, then system 10 can automatically arrange for the appropriate discounts before charging the customer.

System 10 offers a set of tools that help merchants send out promotions, such as alerts, coupons, offer to sell, or any other similar promotion to their consumers thereby increasing the consumer-merchant intimacy. Communicating through the consumer's electronic devices, eliminates the need to use paper, lowers costs, and is time effective. When a consumer signs up for the payments and loyalty program via an embodiment of the present invention, that consumer may, through any enabled point of sale (virtual or physical), receive payments and loyalty programs. A merchant, such as XYZ is able to target a consumer directly on the consumer's electronic device based on that consumer's registered profile. A registered merchant may, if desired, be given access to consumer profile database 13. If, for example, XYZ chooses to send a 5% off coupon to all consumers who are open to receiving marketing material from XYZ, system 10 triggers an XYZ coupon to those consumers, via consumer profile engine 14 which searches consumer profile database 13 to find the appropriate consumers. The coupons may be triggered based on sex, age, prior purchase, economic profile, or any other aspects of a consumer profile.

The consumer receives the promotion on his/her electronic device via SMS, voice, or other appropriate format. Every promotion, for example, “5% off your next visit to XYZ by the end of the next month,” may be characterized by, among other things, the message, start date, expiration date, sender, unique identification code (merchant or non-merchant specific), and offer. Once the promotion is received (either as a text message or a voice mail), it may be redeemed in various ways.

For SMS/Text messages, a promotion received on an electronic device can be redeemed by a consumer replying to the message or by the consumer forwarding the text message to coupon server 17. Upon reply, the promotion, say a coupon, is sent to coupon server 17 which recognizes the sender, the coupon code, and the merchant and registers it for redemption. Post redemption, the coupon may be stored on device 11 itself, and/or in a database, such as consumer profile database 13, for use at the time of making the actual transaction.

In one example, if merchant XYZ is running a promotional offer for tickets to a play, a message offering tickets is transmitted to the consumer's device. The consumer, by responding could select a date and book the tickets from device 11, if desired. When device 11 is wireless, the consumer could complete the transaction from anywhere in the world, provided he/she wirelessly connected to the system 10. Also, from time to time, a consumer could log on, for example, via network 102, to obtain promotion messages and, if desired, respond thereto. Such promotional offers are not limited to tickets, but may be for any good or service a merchant has available. The promotion may also take the form of an offer for sale of a good or service that is immediately purchasable by the consumer. The consumer may receive on his/her electronic device via, SMS, voice or other appropriate format an offer for 50% off the purchase of tickets to an upcoming show. The tickets may then be immediately purchasable by the consumer by replying to the promotion.

Embodiments such as system 10 may be used to distribute any promotion to targeted consumers, as well as generate and distribute promotions when consumers, who are not specifically targeted, request them. Rather than selecting specific consumers, a merchant may choose to advertise (using a bill board, radio, television, newspaper, or any other suitable method), prompting a requesting consumer to then contact system 10 for the promotional offer. The requesting consumer may be prompted to dial a phone number, send a test message, send an email, or use any other suitable contact method to request a coupon from system 10.

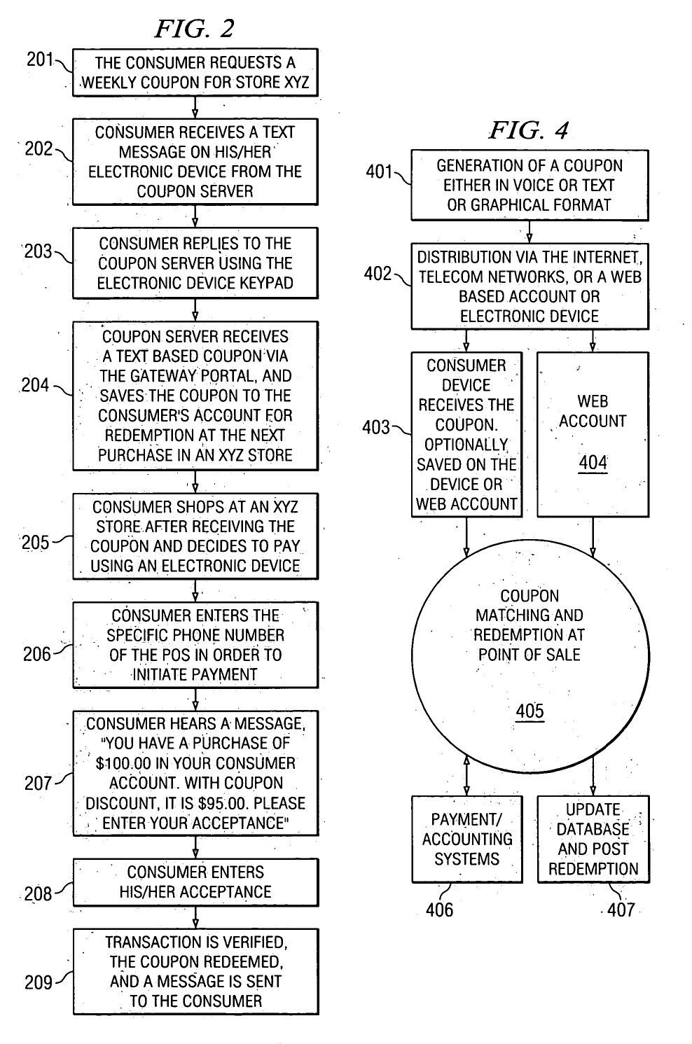

FIG. 2 illustrates one method of electronic coupon redemption via text messaging according to an embodiment of the present invention. Although the depicted embodiment is illustrated and described using coupons, the method of FIG. 2 is readily adapted to any promotion type. In step 201, the consumer requests a weekly coupon for an XYZ store. In step 202, the consumer receives a text message on his/her electronic device from coupon server 17 indicating that the consumer has been sent a coupon based on merchant promotions, consumer request, and/or consumer profile. In step 203, the consumer replies to the coupon server using the electronic device keypad. In step 204, the coupon server receives a text based coupon (for example, using SMS) via system 10, and saves the coupon to the consumer's account for redemption at the next purchase in an XYZ store.

In step 205, the consumer shops at an XYZ store after receiving the coupon and decides to pay using an electronic device. In step 206, the consumer enters the specific phone number of the POS in order to initiate payment.

In step 207, the consumer hears a message, such as, for example, “You have a purchase of $100.00 in your consumer account. With coupon discount, this purchase will be is $95.00. Please accept the transaction.” This acceptance can be verbal, or text based or numerically controlled using, if desired, a PIN number. In step 208, the consumer enters his/her acceptance (PIN or otherwise). In step 209, the transaction is verified, the coupon redeemed, and a message (text, voice, or numerical) is sent to the consumer. This message could be SMS controlled.

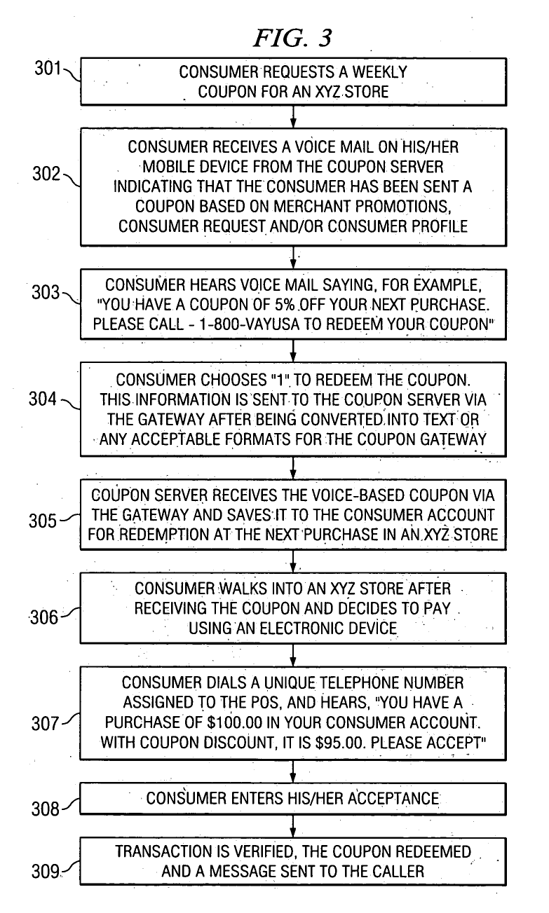

A voice based promotion system may ask the consumer to dial an 800 number to redeem a coupon that, when accepted, is saved to the consumer's account and used at the time of payment. FIG. 3 illustrates a method of electronic coupon redemption via voice messaging according to an embodiment of present invention. Although the depicted embodiment is illustrated and described using coupons, the method of FIG. 3 is readily adapted to any promotion type. In step 301, the consumer requests a weekly coupon for an XYZ store. In step 302, the consumer receives a voice mail on his/her electronic device from the coupon server indicating that the consumer has been sent a coupon based on merchant promotions, consumer request and/or consumer profile.

In step 303, the consumer hears a voice mail saying, for example, “You have a coupon of 5% off your next purchase. Please call-1-800-xxx-xxxx to redeem your coupon.” Upon dialing the number the consumer hears, “You have a coupon waiting for your next purchase at an XYZ store. Please push 1 to redeem the coupon, push 2 to delete the coupon, or push 3 to forward the coupon to a friend.” In step 304, the consumer chooses 1 to redeem the coupon. In other embodiments, each promotion may have an identifying number that a consumer may enter to identify the promotion. The coupon is sent back to the coupon server via the gateway after being converted into text or any acceptable formats for the coupon gateway.

In step 305, the coupon server receives the voice-based coupon via the gateway and saves it to the consumer account for redemption at the next purchase in an XYZ store. In step 306, the consumer shops at an XYZ store after receiving the coupon and decides to pay using his/her electronic device.

In step 307, the consumer dials a unique telephone number assigned to the POS, or dials a server number and identifies the POS. The consumer, for example, hears “You have a purchase of $100.00 in your consumer account. With coupon discount, it is $95.00. Please accept.” This can be done by entering a PIN or other acceptance method. In step 308, the consumer enters his/her acceptance, by using a PIN, or otherwise. In step 309, the transaction is verified, the coupon redeemed and a message is sent to the caller informing the caller of the transaction.

FIG. 4 illustrates a promotion distribution and redemption process in accordance with one embodiment. In process 401, the system generates a coupon in voice, text, or graphical format. This coupon is distributed, under control of process 402, to the consumer. This distribution can be via the web, or directly via a telephone network, or via the Internet. A consumer receives an electronic coupon on the consumer's electronic device 403, or on the consumer's web account 404. The coupon can be optionally saved on the device or in the consumer database at platform 101. The consumer may then redeem these coupons at a point of sale under process 405 when the consumer chooses to pay, process 406, through an appropriate system at process 407. The consumer databases are optimally updated.

The methods and systems of the present invention have been described in part as using payment methods described in the above-identified patent application. The embodiments of the present invention are not limited to these methods, but rather may be used with any appropriate electronic payment system.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for distributing promotions, said method comprising:
generating said promotions for use by specific consumers;
transmitting data relating to said promotion to electronic devices of said specific consumers; and
applying said promotion to a purchase using said electronic device.

2. The method of claim 1 wherein said promotion is a coupon, a discount, an alert, or an offer to sell.

3. The method of claim 1 further comprising:
receiving a response from at least one of said consumers redeeming said promotion.

4. The method of claim 3 further comprising:
processing each said redemption in accordance with rules established by a merchant associated with said promotion redemption.

5. The method of claim 1 further comprising:
storing said promotion in an electronic account for later use by said consumer, wherein said electronic account is accessible by said consumer at a point of sale.

6. The method of claim 1 wherein said electronic device is a mobile device.

7. The method of claim 1 wherein said transmitted data is a text message.

8. The method of claim 1 wherein said transmitted data is a voice mail message.

9. The method of claim 1 wherein said promotion is generated based upon a request made by said consumer.

10. The method of claim 1 wherein said promotion is generated using a profile of said consumer.

11. The method of claim 1 wherein said application of said promotion is automatic.

12. The method of claim 1 further comprising:
identifying said consumer by identifying said electronic device.

13. A method of receiving and redeeming promotions, said method comprising:
accessing, with an electronic device, data, relating to said promotion, transmitted to said electronic device from a server;
redeeming said promotion by replying to said server using said electronic device; and
saving said redeemed promotion to an electronic account.

14. The method of claim 13 wherein said promotion is a coupon, a discount, an alert, or an offer to sell.

15. The method of claim 13 wherein said electronic device is mobile.

16. The method of claim 13 wherein said consumer requests said promotion from said server by using said electronic device.

17. The method of claim 13 wherein said server generates said promotion based, in part, on a merchant profile and on a consumer profile.

18. The method of claim 13 wherein said electronic account is remotely accessible by said consumer.

19. The method of claim 13 wherein said redeeming occurs at a point of sale (POS) and wherein said POS uses a payment method controlled, at least in part, by said electronic device.

20. The method of claim 19 wherein said promotion is automatically applied to a purchase when said purchase is made using said electronic device.

21. The method of claim 13 wherein said redeeming is by telephone, text message, or multi-media message.

22. A method of distributing a promotion, said method comprising:
generating said promotion for use by a consumer;
sending promotion data to a consumer web portal account; and
saving said promotion in a promotion saving account for later use by said consumer for a purchase at a point of sale (POS).

23. The method of claim 22 wherein said promotion may be accessed by an electronic device.

24. The method of claim 23 wherein said electronic device is a mobile device.

25. The method of claim 22 wherein said promotion saving account is accessible by said electronic device.

26. A method for distributing a promotion, said method comprising:
generating said promotion for use by a targeted consumer, wherein said targeted consumer is selected from a plurality of potential consumers; and
transmitting data relating to said promotion to an electronic device of said consumer.

27. The method of claim 26 wherein each of said potential consumers has a consumer profile and said targeted consumer is selected based on said targeted consumer's consumer profile.

28. The method of claim 27 wherein said consumer profiles are stored in a consumer profile database.

29. The method of claim 28 wherein a merchant selects at least one characteristic related to said consumer profiles of said potential consumers and distributes said promotion to each potential consumer having said characteristic in their said consumer profile.

30. A method of distributing a promotion, said method comprising:
generating said promotion for use by a requesting consumer, wherein said requesting consumer is prompted to request said promotion; and
transmitting data relating to said promotion to an electronic device of said consumer.

31. The method of claim 30 wherein said requesting consumer is prompted by an advertisement.

32. The method of claim 31 wherein said advertisement is a billboard, a radio advertisement, a television advertisement, or a newspaper advertisement.

33. The method of claim 30 wherein said requesting consumer contacts a distributor to request said promotion.

34. The method of claim 33 wherein said distributor comprises a promotion distributing server.

35. The method of claim 34 wherein said requesting consumer contacts said distributor by calling a telephone number, sending an email message, or sending a text message.

36. The method of claim 30 wherein said promotion is stored for later use by said consumer.

37. A method for distributing a promotional offer to a targeted consumer, said method comprising:
transmitting said offer to an electronic device of said targeted consumer, wherein said targeted consumer is selected from a plurality of potential consumers;
receiving a reply from said targeted consumer in response to said promotional offer; and
facilitating a purchase by said targeted consumer, said purchase correlated to said promotional offer.

38. The method of claim 37 wherein each of said potential consumers has a consumer profile and wherein said targeted consumer is selected based on said targeted consumer's consumer profile.

39. The method of claim 38 wherein said consumer profiles are stored in a consumer profile database.

40. The method of claim 39 wherein a merchant selects at least one characteristic of said consumer profiles of said potential consumers and distributes said promotional offer to each potential consumer having said characteristic in their said consumer profile.

41. A system for distributing and redeeming a promotion, said system comprising:
a processor for generating promotion data;
an electronic device operable for receiving generated promotion data; and
a database accessible by said processor, said database operable in conjunction with said processor for storing information used for generating said promotion.

42. The system of claim 41 wherein said electronic device is further operable to transmit to said system a request by a consumer for said promotion.

43. The system of claim 41 wherein said electronic device is a mobile device.

44. The system of claim 41 further comprising:
a merchant database accessible by said processor, and operable to store information associated with at least one merchant used to generate said promotion.

45. The system of claim 41 further comprising:
a consumer database accessible by said processor and operable to store information associated with at least one consumer and used to generate said promotion.

46. The system of claim 41 further comprising:
a consumer database wherein said promotion can be stored for later redemption by said consumer.

47. The system of claim 41 wherein said system utilizes XML or J2EE technology.

48. The system of claim 41 wherein said system has an Internet interface.

49. A method for consumer contact, said method comprising:
accessing a consumer database containing at least one profile of at least one consumer;
transmitting, to a mobile electronic device of a consumer, data relating to a promotion, wherein said promotion is generated from the profile of said consumer; and
matching said promotion with a merchant profile in a merchant profile database when said consumer uses said promotion in an electronic purchase.

50. The method of claim 49 wherein said promotion is a coupon, a discount, an alert, or an offer to sell.

51. The method of claim 49, said method further comprising:
receiving a response from said consumer redeeming said promotion.

52. The method of claim 49 wherein buying habits of said consumer are recorded in said consumer profile.

53. The method of claim 49 wherein said promotion is generated using said consumer buying habits.

54. The method of claim 49 further comprising:
receiving by said processor consumer requests for promotions.

55. A mobile electronic device comprising:
means for requesting data regarding a promotion from a remote server;
means for receiving said data from said remote server; and
means for applying received promotion data when a purchase is made at a point of sale (POS).

56. The device of claim 55 further comprising:
means for storing information related to said promotion; and
means for reading said stored promotion information at said POS.

57. The device of claim 55 wherein said device is uniquely identifiable by said remote server.

58. The device of claim 55 wherein said device is a mobile telephone and the unique identification is the telephone number.

59. The device of claim 55 wherein said requesting and said receiving means utilize DTMF technology.

60. The device of claim 55 wherein said device is capable of text messaging and wherein said requesting and receiving means utilize XML or J2EE technology.

61. A system for redeeming promotions, said system comprising:
means for identifying a redeemable promotion;
an electronic device associated with particular consumer; and
means for receiving from said electronic device associated with said particular consumer an acceptance of said promotion.

62. The system of claim 61 wherein said identifying means comprises:
means for associating a particular transaction at a point of sale (POS) with said redeemable promotion; and
means for communicating said associated transaction to said electronic device associated with said particular consumer.

63. The system of claim 62 further comprising:
means operable in response to communications from said electronic device for coordinating payment for said associated transaction.

64. The system of claim 61 wherein said electronic device is wireless.

65. The system of claim 63 wherein said wireless electronic device is a cell phone.

66. A system for coordinating transactions, said system comprising:
a server for accepting over a temporarily established communication connection from anyone of a plurality of users information specific to one of many merchants, said information including data specific to a unique POS location of one of said merchants;
means for coordinating said received information from a specific one of said users with information available to said server pertaining to said unique merchant location;
means for communicating at least a portion of said coordinated information to said one user over said temporarily established connection, said coordinated information including promotional information associated with said specific user; and
means for coordinating the redemption of the promotion associated with said promotional information.

67. The system of claim 66 wherein said information to said one user comprises:
cost information pertaining to said information obtained from said specific location, said cost information discounted by said promotion information.

68. The system of claim 67 further comprising:
means at said server for accepting further information from said one user, said further information comprising acceptance information for both said cost information and said promotion information.

69. The system of claim 68 further comprising:
means at said server for coordinating payment to said one merchant from said one user, said payment based upon said information communicated to said user and said acceptance information from said user.

70. A method for coordinating transactions, said method comprising:
accepting over a temporarily established communication connection from anyone of a plurality of users information specific to one of many merchants, said information including data specific to a unique location of one of said merchants, said specific data pertaining to merchandise obtained from said merchant;
coordinating said received information from a specific one of said users with available information pertaining to said unique merchant location; and
communicating at least a portion of said coordinated information to said one user over said temporarily established connection, said coordinated information including promotions available to said specific one of said users pertaining to said obtained merchandise.

71. The method of claim 70 wherein said information to said one user comprises:
cost information pertaining to said information obtained from said specific location, said cost information including any modifications thereto based upon said communicated promotion.

72. The method of claim 71 further comprising:
accepting further information from said one user, said further information comprising acceptance information for said cost information and for said promotion.

73. The method of claim 72 further comprising:
coordinating payment to said one merchant from said one user, said payment based upon said information communicated to said user and said acceptance information from said user, including acceptance or rejection of said promotion.

74. The method of coordinating the purchases from a merchant to a consumer, said method comprising:
establishing, under control of said consumer at a POS terminal when purchase information is entered by said merchant at said POS terminal, a temporary communication connection to a server independent from said merchant for coordinating preestablished payment options with respect to said purchase information; and
under control of said server and upon receipt of the location ID of said POS terminal and other information entered by said consumer, providing to said merchant sufficient information to satisfy said merchant that said consumer has arranged proper payment for said purchase, and that all promotions associated with said consumer and with said purchase information have been identified and applied.

75. The method of claim 74 wherein said payment sufficient information includes any payment reductions available under any affinity programs available to said consumer.
